(19) United States
(12) Patent Application Publication
(10) Pub. No.: US 2025/0307629 A1
(43) Pub. Date: Oct. 2, 2025

(54) METHOD AND SYSTEM FOR ASSESSING ACCURACY OF PREDICTION OBTAINED FROM A MACHINE LEARNING MODEL

(71) Applicant: HCL Technologies Limited, NEW DELHI (IN)

(72) Inventors: Tathagata Chakraborty, Pune (IN); Christine Zuzart, Pune (IN); Chinmaya Panda, Navi Mumbai (IN); Nitin Umap, Pune (IN)

(21) Appl. No.: 19/077,096

(22) Filed: Mar. 12, 2025

(30) Foreign Application Priority Data
Mar. 30, 2024 (IN) 202411026501

(51) Int. Cl. G06N 3/08

(52) U.S. Cl. CPC G06N 3/08

(57) ABSTRACT

The disclosure relates to a method and system of generating training data for fine-tuning of a Machine Learning (ML) model. The method includes generating one or more natural language interpretations of a dataset corresponding to one or more parameters associated with configuration of the dataset, and collating the one or more natural language interpretations of the dataset corresponding to one or more parameters, to generate a combined natural language interpretation of the dataset. The method further include generating a conceptual explanation of the dataset, based on the combined natural language interpretation of the dataset, and assigning one or more labels to each sub-dataset of the dataset, based on the conceptual explanation of the dataset, to generate training data for fine-tuning of the ML model, wherein the dataset comprises a plurality of sub-datasets.

### TECHNICAL FIELD

This disclosure relates generally to obtaining predictions from Machine Learning (ML) models, and in particular, to a method and a system for assessing accuracy of a prediction obtained from the ML models.

### BACKGROUND

Machine Learning (ML) models, such as Deep Neural Networks (DNNs) have achieved popularity and success in recent times. However, it is challenging to deploy DNNs in mission-critical systems. One reason is that DNNs often give over-confident results on classification problems and do not, by default, report any measure of confidence along with the output on regression problems. DNNs are, therefore, primarily used in domains with alternative mechanisms to detect and correct such errors. As such, DNNs are rarely deployed in systems where a single error can derail the whole computation.

Accuracy assessment of predictions from the DNN (or any other ML model) is a long-standing open problem. For classification problems, various techniques have been tried for determining a confidence score for the results generated by the ML model. For example, penultimate layers of the ML model are analyzed to determine a confidence score, or the ML model is trained to recognize outliers and report them during inference. However, not many solutions are known for regression models.

Therefore, there is a need for effective and efficient solutions that provide for assessing the accuracy of a prediction obtained from the ML model.

### SUMMARY

In an embodiment, a method of assessing accuracy of a prediction obtained from a machine learning (ML) model is disclosed. The method may include obtaining, from the ML model: a primary predicted value associated with a primary parameter and a secondary predicted value associated with each of one or more secondary parameters. The ML model may be trained on training data corresponding to the primary parameter as well as the one or more secondary parameters. The secondary predicted value may be partially dependent on the primary predicted value. The method may further include obtaining a measured value associated with each of the one or more secondary parameters, in response to an action performed based on the primary predicted value. The method may further include comparing the measured value with the secondary predicted value, for each of the one or more secondary parameters, and determining an accuracy score corresponding to the accuracy of the primary predicted value for the action performed, based on the comparison.

In another embodiment, a system for assessing accuracy of a prediction obtained from a ML model is disclosed. The system includes a processor and a memory communicatively coupled to the processor. The memory stores a plurality of processor-executable instructions, which upon execution by the processor, cause the processor to obtain, from the ML model: a primary predicted value associated with a primary parameter and a secondary predicted value associated with each of one or more secondary parameters. The ML model may be trained on training data corresponding to the primary parameter as well as the one or more secondary parameters. The secondary predicted value may be partially dependent on the primary predicted value. The plurality of processor-executable instructions, upon execution by the processor, further cause the processor to obtain a measured value associated with each of the one or more secondary parameters, in response to an action performed based on the primary predicted value. The plurality of processor-executable instructions, upon execution by the processor, further cause the processor to compare the measured value with the secondary predicted value, for each of the one or more secondary parameters, and determine an accuracy score corresponding to the accuracy of the primary predicted value for the action performed, based on the comparison.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for assessing accuracy of a prediction obtained from a machine learning (ML) model, in accordance with some embodiments of the present disclosure.

FIG. 2 is a block diagram of the ML model showing various layers and outputs from the ML model, in accordance with some embodiments.

FIG. 3 is a functional block diagram of an accuracy assessing device showing one or more modules, in accordance with some embodiments.

FIG. 4 is a flowchart of a process of training the ML model, in accordance with some embodiments.

FIG. 5A illustrates a schematic representation of training data for training the ML model (without taking into consideration secondary parameters), in accordance with some embodiments.

FIG. 5B illustrates a schematic representation of training data for training the ML model (taking into consideration secondary parameters), in accordance with some embodiments.

FIG. 6 is a flowchart of a method of assessing accuracy of a prediction obtained from the ML model, in accordance with some embodiments.

FIG. 7 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

Machine Learning (ML) models or neural networks are prone to giving over-confident results. Some of the reasons for the over-confident results include high model capacity, misalignment with training data, and calibration issues with the network. Present day ML models have a very large number of parameters, which helps the ML models make accurate predictions on the training set. To enable the ML models to generalize and perform well on the test or held-out data, regularization techniques are incorporated into the ML models. The regularization techniques can prevent overfitting by penalizing complex models, and also reduce overconfidence in predictions by discouraging overly complex decision boundaries. However, getting the amount of regularization just right can be challenging. Additionally, most classification models optimize cross-entropy loss. However, in the process of the computing the cross-entropy loss, the ML models may make very confident predictions.

ML models give over-confident answers when they encounter out of sample inputs that are far from the data they were trained on. This is because the ML model has little idea as to handling this data. It may not be possible or practical to train the ML models on all possible cases (i.e. data samples), since the dataset required will be very large. Similarly, training the ML models to recognize all types of adversarial inputs is also challenging. Further, it is challenging to obtain large amount of data required for training. Furthermore, training time is also adversely affected by the size of the training data. Also, ML models are often not well calibrated. One reason for this is that ML models are trained on a finite dataset, which is not always representative of the complete data. The non-linear nature of the ML models also leads to calibration issues. ML model calibration can be improved by using ensemble methods where the outputs of multiple models are averaged before making a prediction. Regularization techniques can improve the calibration of neural networks. However, it is difficult to get the calibration right when the input space is vast, and it is difficult to anticipate all the possible inputs and training the network to handle them. Unlike classification models, it is more challenging to determine the confidence interval for regression models. However, an estimate of the confidence interval can be made using an ensemble of models, which provide a distribution of predictions from which such an interval can be calculated.

Existing methods for determining the confidence of neural networks are all generic methods applicable irrespective of the problem domain. To this end, the present subject matter provides for techniques that include training the ML model to predict one or more additional and redundant values related to the system. The techniques further include verifying the computed redundant values with the predicted redundant values to determine the accuracy of the prediction, based on the action performed by the model (assuming that the predicted value must be actionable by the system). Additionally, the techniques are able to provide for backtracking at least one step when the estimated accuracy is low.

The techniques further provide for counter-intuitively training the ML model to predict additional redundant values (also, referred to as secondary predicted values associated with one or more secondary parameters). The redundant values help in determining the accuracy of the prediction, add an inductive bias to the ML model, and help guide the optimization of the ML model in the right direction. This ensures that the ML model learns the right abstractions and does not figure out shortcuts (based on unrelated quirks) to improve accuracy. The ML model is guided correctly if the predicted value does not wholly determine the additional redundant parameters.

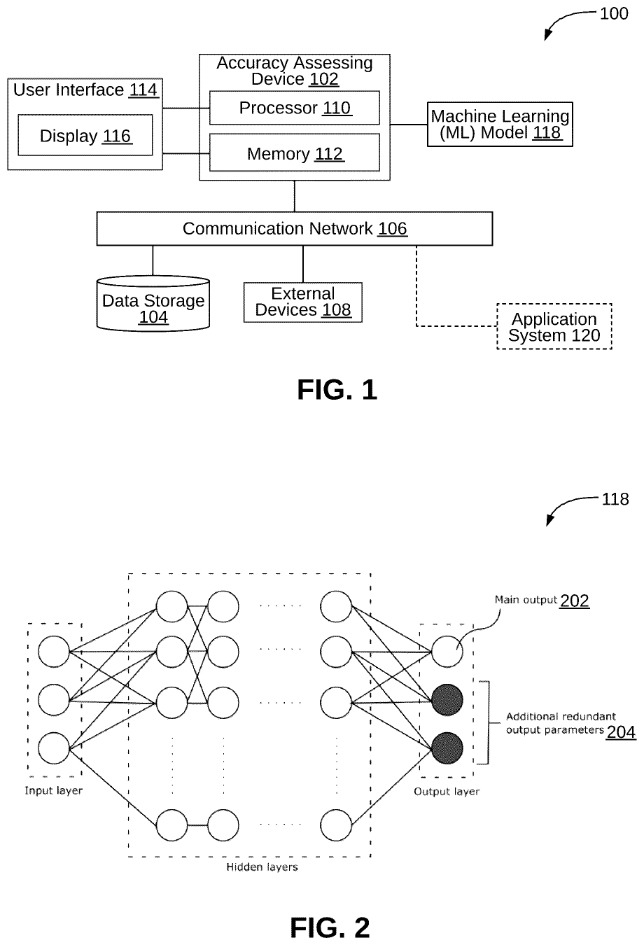

Referring now to FIG. 1, a block diagram of an exemplary system 100 for assessing accuracy of a prediction obtained from a machine learning (ML) model is illustrated, in accordance with some embodiments of the present disclosure. The system 100 may implement an accuracy assessing device 102. Further, the system 100 may include a data storage 104. In some embodiments, the data storage 104 may store at least some of the data related to the ML model. The accuracy assessing device 102 may be a computing device having data processing capability. In particular, the accuracy assessing device 102 may have the capability for assessing accuracy of a prediction obtained from the ML model. Examples of the accuracy assessing device 102 may include, but are not limited to a desktop, a laptop, a notebook, a netbook, a tablet, a smartphone, a mobile phone, an application server, a web server, or the like.

Additionally, the accuracy assessing device 102 may be communicatively coupled to an external device 108 for sending and receiving various data. Examples of the external device 108 may include, but are not limited to, a remote server, digital devices, and a computer system. The accuracy assessing device 102 may connect to the external device 108 over a communication network 106. The accuracy assessing device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108. For example, the communication network 120 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the accuracy assessing device 102 and the data storage 104 and the external device 108.

The accuracy assessing device 102 may be configured to perform one or more functionalities that may include obtaining, from the ML model: a primary predicted value associated with a primary parameter and a secondary predicted value associated with each of one or more secondary parameters. The ML model may be trained on training data corresponding to the primary parameter as well as the one or more secondary parameters. The secondary predicted value may be partially dependent on the primary predicted value. The one or more functionalities may further include obtaining a measured value associated with each of the one or more secondary parameters, in response to an action performed based on the primary predicted value. The one or more functionalities may further include comparing the measured value with the secondary predicted value, for each of the one or more secondary parameters, and determining an accuracy score corresponding to the accuracy of the primary predicted value for the action performed, based on the comparison.

To perform the above functionalities, the accuracy assessing device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the accuracy assessing device 102.

The accuracy assessing device 102, therefore, causes to predict a secondary value associated with each of one or more secondary parameters related to an application system 120 on which the ML model 118 is applied. The accuracy assessing device 102 may verify primary predicted value using the secondary predicted value, to determine the accuracy of the prediction, based on the action predicted by the ML model 118. Additionally, the accuracy assessing device 102 may provide for backtracking at least one action, when the accuracy of the prediction is low.

FIG. 2 illustrates a block diagram of the ML model 118 showing various layers and outputs from the ML model 118, in accordance with some embodiments. As shown, the ML model 118 may be trained to predict primary value (i.e. main value) 202 as well as counter-intuitively predict secondary value 204 associated with each of one or more secondary parameters. The secondary predicted value 204 helps in determining the accuracy of the prediction of the primary value 202, add an inductive bias to the ML model 118, and help guide the optimization of the ML model 118 in the right direction. This ensures that the ML model 118 learns the right abstractions and does not figure out shortcuts to improve accuracy. The ML model 118 is guided correctly if the predicted primary value 202 does not wholly determine the secondary predicted value 204.

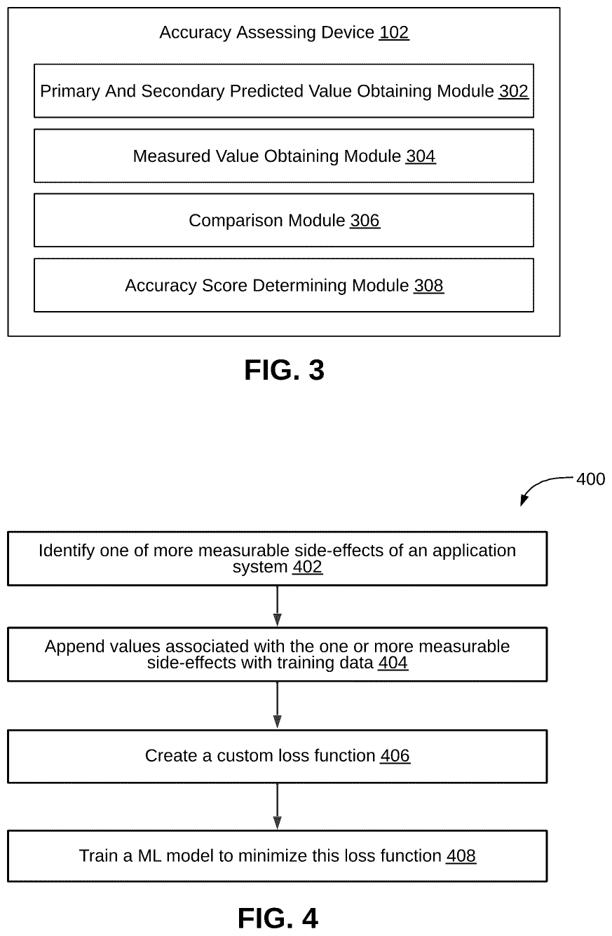

Referring now to FIG. 3, a block diagram of the accuracy assessing device 102 showing one or more modules is illustrated, in accordance with some embodiments. In some embodiments, the accuracy assessing device 102 may include a primary and secondary predicted value obtaining module 302, a measured value obtaining module 304, a comparison module 306, and an accuracy score determining module 308.

The primary and secondary predicted value obtaining module 302 may be configured to obtain from the ML model 118: a primary predicted value associated with a primary parameter and a secondary predicted value associated with each of one or more secondary parameters. The ML model 118 may be trained on training data corresponding to the primary parameter as well as the one or more secondary parameters. The secondary predicted value may be partially dependent on the primary predicted value.

As will be appreciated by those skilled in the art, the ML model 118 can be trained only on a finite amount of data. The ML model 118 may have generalization ability to predict on out-of-sample data. Generalizability requires some form of regularization, due to which the ML model 118 cannot be fully accurate. Further, the training data may have some uncertainty, and the architecture of the ML model 118 may cause data compression that further decreases its accuracy.

In order to address the above, the ML model 118 may be trained to predict primary predicted value (associated with the primary parameter) and the secondary predicted value (associated with each of one or more secondary parameters). The secondary predicted value(s) may add an inductive bias to the ML model 118 and can help guide the optimization of the ML model 118 in the right direction, thereby ensuring that the ML model 118 learns the right abstractions and does not figure out shortcuts (based on unrelated quirks), to improve accuracy on the training data. The ML model 118 may be guided correctly if the primary predicted value does not wholly determine the secondary predicted value(s). Training of the ML model 118 is explained in conjunction with FIG. 3.

FIG. 4 is a flowchart of a process 400 of training the ML model 118, in accordance with some embodiments. At step 402, one of more measurable side-effects (also referred to as “secondary parameters”) of an application system (on which the prediction from the ML model 118 is implemented) may be identified. For example, the application system may be simulated metal cutting system (i.e. digital twin of the metal cutting system) that may be configured to simulate cutting operation on a metal piece. In order to perform the cutting operation, the simulated metal cutting system may be fed with predictions from the ML model 118. As mentioned above, the predictions from the ML model 118 may include the primary predicted value associated with a primary parameter, and the secondary predicted value associated with each of one or more secondary parameters. For example, the primary parameter may include the direction of the cutting, and therefore, the primary predicted value may include a direction (i.e. In terms of Cartesian coordinates) for the cutting operation. The secondary parameter may include an amount of material removed during the cutting operation, and therefore, the secondary predicted value may include a predicted value of the amount of material that should be removed as a result of performing the cutting operation along the predicted direction (i.e. primary predicted value). As such, the secondary predicted value is partially dependent on the primary predicted value.

At step 404, the values associated with the one or more measurable side-effects (i.e. secondary predicted value associated with each of one or more secondary parameters) may be appended to the training data. At step 406, a custom loss function may be created that scales the losses computed for the different parameters and brings them in approximately the same range. Alternatively, each of the parameters may be scaled before training the ML model 118. At step 408, the ML model 118 may be trained to minimize this loss function.

Referring back to FIG. 3, once the primary and secondary predicted value obtaining module 302 obtains the primary predicted value associated with the primary parameter and the secondary predicted value associated with each of one or more secondary parameters from the ML model 118, an action may be performed by the application system, based on the primary predicted value.

The measured value obtaining module 304 may obtain a measured value associated with each of the one or more secondary parameters, in response to the action performed based on the primary predicted value. As will be understood, the primary predicted value is actionable by the application system. Upon performing the action based on the primary predicted value, the application system may be able to measure the value associated with each of the one or more secondary parameters. The measured value associated with each of the one or more secondary parameters is, therefore, an effect of the action taken by the application system.

The comparison module 306 may compare the measured value associated with each of the one or more secondary parameters with the secondary predicted value associated with each of one or more secondary parameters.

The accuracy score determining module 308 may determine an accuracy score corresponding to the accuracy of the primary predicted value for the action performed, based on the comparison. In other words, the accuracy score determining module 308 may determine the accuracy score based on the difference between the measured values and the predicted values of the additional parameter.

The accuracy score determining module 308 may further compare the accuracy score with a predefined threshold value. When the accuracy score is greater than the predefined threshold, then the predicted value (i.e. secondary predicted value associated with each of one or more secondary parameters) by the ML model 118 is accepted. In other words, when the difference between the measured values and the predicted values of the additional parameter is insignificant, then the predicted value (i.e. secondary predicted value associated with each of one or more secondary parameters) by the ML model 118 may be accepted. However, when the accuracy score is lower than the predefined threshold, then the predicted value (i.e. secondary predicted value associated with each of one or more secondary parameters) by the ML model 118 may not be accepted, and the action corresponding to the primary predicted value may be reversed. In other words, when the difference between the measured values and the predicted values of the additional parameter is significant, then the action corresponding to the primary predicted value may be reversed.

The above techniques as performed by the accuracy assessing device may be applied on simulation-driven applications. When used in the context of simulation-driven methods, ML models 118, such as Deep Neural Networks (DNNs; the terms “ML model” and “DNN” may have been used interchangeably in this disclosure), may be used to drive the simulation forward. The output of the DNNs may be actionable items. Additionally, a simulation-driven method provides several additional side effects (i.e. secondary parameters) that can be measured and used to verify the accuracy of the output from the DNN. For example, the above techniques may be applied to the DNN for accelerating a simulation-driven technique for toolpath generation for the machining of 2.5D pockets. Toolpaths define the path that a cutting tool must follow to remove material from a rectangular stock to create a part with the desired shape. The algorithms for creating such toolpaths can be complex and require a lot of effort to develop and maintain. Therefore, simulation-driven methods, that are low-code methods for computing high-speed toolpaths, can be significantly easier to develop.

For toolpath generation, several different directions must be evaluated at each step in the simulation. Thereafter, the most appropriate direction is selected along which the tool should move. As will be appreciated by those skilled in the art, it is possible to analyze the neighborhood of the tool geometrically to determine the next movement direction. However, implementing this process in code is challenging, since a considerable number of cases need to be handled.

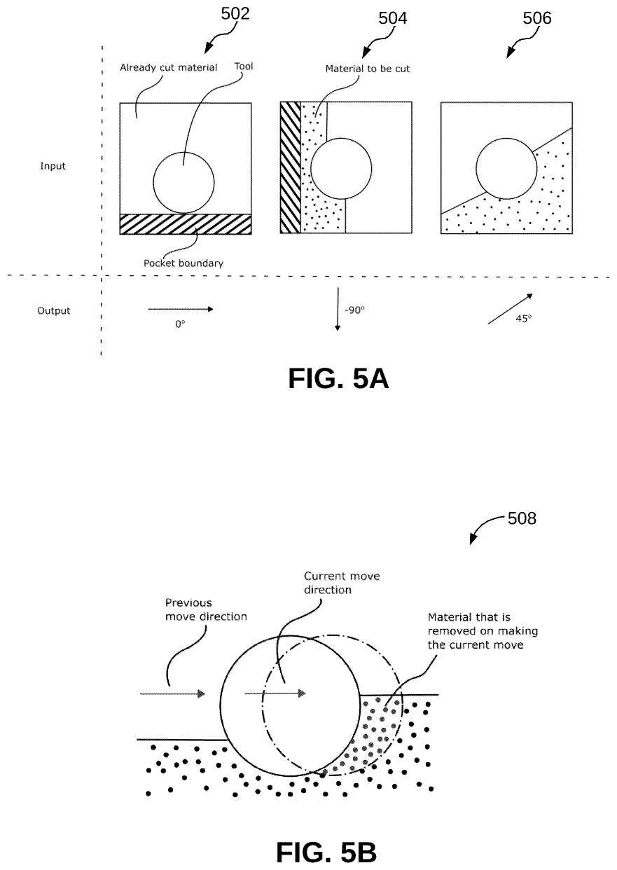

To this end, DNN may be used to accelerate the simulation. The data for training the DNN may be generated by the simulation process itself. The data required for the training may be generated by running the simulation on pockets and tools with different geometries. For example, the input training data may include images of the neighborhood of the tool, and the output data may include an angle of the movement direction with an X-axis, illustrated in FIGS. 5A-5B.

FIG. 5A illustrates a schematic representation of training data for training the ML model 118 (without taking into consideration secondary parameters), in accordance with some embodiments. In particular, FIG. 5 illustrates a first training image 502 data with direction of movement being along the X-axis (i.e. angle being) 0°; a second training image 504 data with direction of movement of the tool being at an angle of −90° with the X-axis; and a third training image 506 data with direction of movement of the tool at an angle of 45° with the X-axis. When the training data includes only the direction (represented by the angle that the cutting tool makes with the X-axis) of movement, then the DNN-based ML model 118 may learn from the data and generalize from the data. For example, the DNN-based ML model 118 may include a Convolutional Neural Network (CNN) or a Vision Transformer (ViT).

ML models are known to predict accurate movement path in 95% of the cases. However, for the remaining 5% of the cases where the ML models predict wrong value (which differs by more than 5° from the accurate value), there is no mechanism to detect when the ML model has erred or has low confidence in the prediction.

As such, in some embodiments, during simulation of material-cutting process, three secondary parameters (i.e. side effects) may be measured, in response to a movement of the tool in a direction. A first secondary parameter may be a measure of new material removed due to the movement. A second secondary parameter may be an engagement angle that represents an angle that spans the boundary of the cutting tool in touch with the material. A third secondary parameter may be an angle of the current movement direction with a previous movement direction. The first and the second secondary parameter may be correlated with each other; hence, any one of the first and the second secondary parameter may be used for further computation. The first and the second secondary parameter may be added (as additional targets) to the training data, shown in FIG. 5B.

FIG. 5B illustrates a schematic representation of training data 508 for training the ML model 118 (taking into consideration secondary parameters), in accordance with some embodiments. Using the training data as shown in FIG. 5B, the ML model 118 may be trained to predict not only the movement direction but also the potential material that will be removed if the tool were to move in this direction. Additionally, the ML model 118 may be trained to predict an angle that the current movement makes with the previous movement. As will be understood, the secondary parameters (first secondary parameter—new material removed due to the movement; second secondary parameter—engagement angle; and the third parameter—an angle of the current movement direction with a previous movement direction) are partially dependent on the primary parameter (i.e. the direction of movement). The secondary parameters additionally depend on the physics and state of the system.

During operation, the prediction of the movement direction is used to move the tool in the simulated environment. Thereafter, an amount of material removed is measured, and an angle with the previous direction is computed. These values (i.e. the amount of material removed and the angle with the previous direction) may be compared with the corresponding parameters that were additionally predicted by the ML model 118. The magnitude of the difference between the computed and predicted values may be used as a measure of the accuracy of the ML model 118.

Therefore, the addition of secondary parameters acts like domain-specific regularization parameters for the ML model 118, thereby adding an inductive bias to the ML model 118 and ensuring that the ML model 118 learns the right abstractions when predicting the tool movement direction. Further, the secondary parameters may be used to determine the accuracy of the prediction made by the ML model 118.

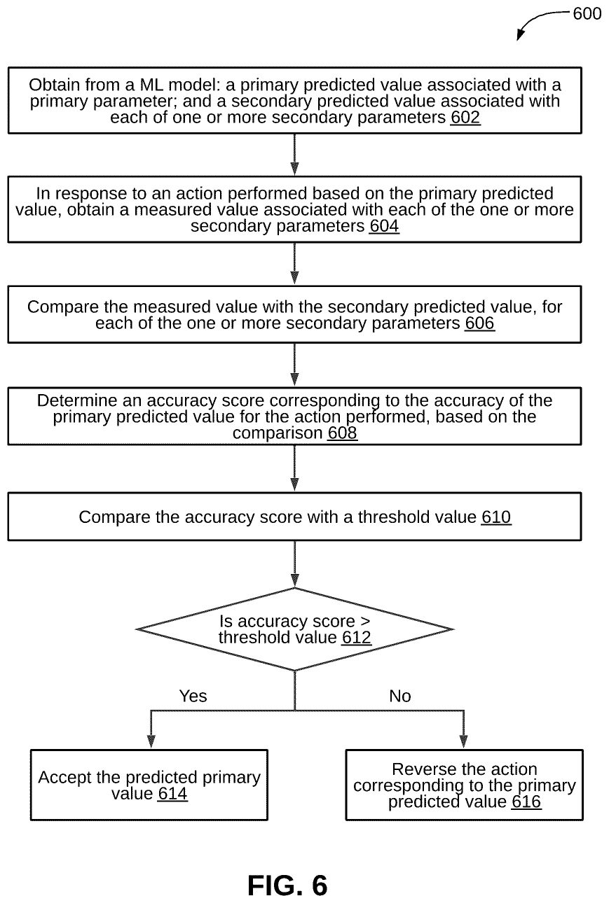

Referring now to FIG. 6, a flowchart of a method 600 of assessing accuracy of a prediction obtained from the ML model 118 is illustrated, in accordance with some embodiments. The method may be performed by the accuracy assessing device 102.

At step 602, a primary predicted value associated with a primary parameter and a secondary predicted value associated with each of one or more secondary parameters may be obtained from the ML model 118. The ML model 118 may be trained on training data corresponding to the primary parameter as well as the one or more secondary parameters. The secondary predicted value may be partially dependent on the primary predicted value. By way of an example, the ML model 118 may be a deep neural network (DNN).

At step 604, a measured value associated with each of the one or more secondary parameters may be obtained, in response to an action performed based on the primary predicted value. It should be noted that the action may be a simulated action performed in a simulation operation. For example, the action may be a real action performed on a digital twin.

At step 606, the measured value may be compared with the secondary predicted value, for each of the one or more secondary parameters. At step 608, an accuracy score may be determined corresponding to the accuracy of the primary predicted value for the action performed, based on the comparison.

At step 610, a check may be performed to determine whether the accuracy score is greater than a predefined threshold value. If, at step 610, it is determined that the accuracy score is greater than the predefined threshold value, the method 600 may proceed to step 612 (“Yes” path). At step 612, the predicted primary value 614 may be accepted. As such, the procedure on the application system may proceed ahead of the action performed. If, at step 610, it is determined that the accuracy score is not greater than the predefined threshold value, the method 600 may proceed to step 614 (“No” path). At step 614, the action corresponding to the primary predicted value 616 may be reversed. In other words, when the accuracy score is low. i.e. lower than the predefined threshold value, the predicted primary value 614, it may indicate that the primary value as predicted by the ML model 118 is not accurate. Therefore, the primary predicted value may not be accepted, and the action corresponding to the primary predicted value 616 may be reversed (e.g. in the simulation operation).

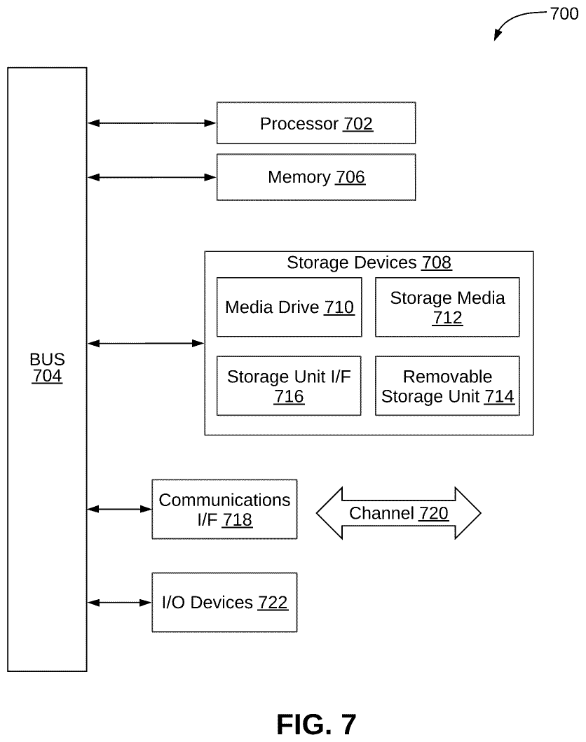

Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 700 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication media. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during the execution of instructions to be executed by processor 702. The computing system 700 may likewise include a read-only memory (“ROM”) or other static storage device coupled to bus 704 for storing static information and instructions for the processor 702.

The computing system 700 may also include storage devices 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 712 may include, for example, a hard disk, magnetic tape, flash drive, or other fixed or removable media that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro-USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or other communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and also display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

One or more techniques for assessing accuracy of a prediction obtained from the ML model are disclosed. The techniques can be applied in engineering domains, especially for simulation-driven methods, and can be used to gauge the accuracy of the predictions made by the ML model. As such, a wrong prediction can be rejected and an alternate method can be used for the particular input that resulted in the wrong prediction. The technique further requires backtracking capability in simulation-driven methods. In particular, for the action (i.e. the primary value) predicted by the ML model, secondary values associated with the secondary parameters are predicted. The secondary predicted values are compared with measured values to verify if they match the secondary predicted values. If the measured values are far from the secondary predicted values, then the primary predicted value is rejected as erroneous, and the corresponding action is reversed.

It is intended that the disclosure and examples be considered as exemplary only, with a true scope and spirit of disclosed embodiments being indicated by the following claims.

What is claimed is:

1. A method for assessing accuracy of a prediction obtained from a machine learning (ML) model, the method comprising:
obtaining, by an accuracy assessing device, from the ML model:
a primary predicted value associated with a primary parameter; and
a secondary predicted value associated with each of one or more secondary parameters, wherein the ML model is trained on training data corresponding to the primary parameter as well as the one or more secondary parameters, wherein the secondary predicted value is partially dependent on the primary predicted value;
in response to an action performed based on the primary predicted value, obtaining, by the accuracy assessing device, a measured value associated with each of the one or more secondary parameters;
comparing, by the accuracy assessing device, the measured value with the secondary predicted value, for each of the one or more secondary parameters; and
determining, by the accuracy assessing device, an accuracy score corresponding to the accuracy of the primary predicted value for the action performed, based on the comparison.

2. The method as claimed in claim 1 further comprising:
comparing the accuracy score with a threshold value; and
reversing the action corresponding to the primary predicted value, when the accuracy score is less than the threshold value.

3. The method as claimed in claim 1, wherein the action is a simulated action performed in a simulation operation.

4. The method as claimed in claim 1, wherein the action is a real action performed on a digital twin.

5. The method as claimed in claim 1, wherein the ML model is a deep neural network.

6. A system for assessing accuracy of a prediction obtained from a machine learning (ML) model, the system comprising:
a processor;
a memory communicatively coupled to the processor, the memory storing a plurality of processor-executable instructions, wherein the processor-executable instructions, upon execution by the processor, cause the processor to:
obtain, from the ML model:
a primary predicted value associated with a primary parameter; and
a secondary predicted value associated with each of one or more secondary parameters, wherein the ML model is trained on training data corresponding to the primary parameter as well as the one or more secondary parameters, wherein the secondary predicted value is partially dependent on the primary predicted value;
in response to an action performed based on the primary predicted value, obtain a measured value associated with each of the one or more secondary parameters;
compare the measured value with the secondary predicted value, for each of the one or more secondary parameters; and
determine an accuracy score corresponding to the accuracy of the primary predicted value for the action performed, based on the comparison.

7. The system as claimed in claim 6, wherein the processor-executable instructions cause the processor to:
compare the accuracy score with a threshold value; and
reverse the action corresponding to the primary predicted value, when the accuracy score is less than the threshold value.

8. The system as claimed in claim 6, wherein the action is a simulated action performed in a simulation operation.

9. The system as claimed in claim 6, wherein the action is a real action performed on a digital twin.

10. The system as claimed in claim 6, wherein the ML model is a deep neural network.
